(19) United States
(12) Patent Application Publication
(10) Pub. No.: US 2014/0132640 A1
(43) Pub. Date: May 15, 2014

(54) AUTO-SCALING OF AN INDOOR MAP

(71) Applicant: QUALCOMM Incorporated, San Jose, CA (US)

(72) Inventors: Abhinav SHARMA, Santa Clara, CA (US); Saumitra Mohan Das, Santa Clara, CA (US); Chandrakant Mehta, Santa Clara, CA (US)

(21) Appl. No.: 13/837,318

(22) Filed: Mar. 15, 2013

Related U.S. Application Data
(60) Provisional application No. 61/726,450, filed on Nov. 14, 2012.

(51) Int. Cl. G06T 3/40

(52) U.S. Cl. CPC G06T 3/40
USPC 345/661

(57) ABSTRACT

A computer-implemented method of auto-scaling an indoor map includes receiving an unsealed electronic map that shows a floor plan of a building and creating control points on the unsealed electronic map. Each of control points includes an absolute coordinate pair and a corresponding local coordinate pair. The method also includes calculating a primary scaling factor based on the control points. The electronic map is then auto-scaled using the primary scaling factor to generate a scaled electronic map that shows the floor plan of the building.

### CROSS-REFERENCE TO RELATED APPLICATION

This application claims the benefit of U.S. Provisional Application No. 61/726,450, filed Nov. 14, 2012. U.S. Provisional Application No. 61/726,450 is hereby incorporated by reference.

### TECHNICAL FIELD

This disclosure relates generally to electronic maps, and in particular but not exclusively, relates to electronic maps for use in indoor navigation.

### BACKGROUND INFORMATION

Navigation systems are becoming more and more pervasive in today's market. A navigation system may be utilized to determine a route from a first location to a destination. In some navigation systems, a user may enter a start location and a destination into a mapping application, such as one of the different mapping applications commonly used on a variety of websites.

Navigation systems may be utilized within an indoor environment, such as a shopping mall, to guide a user to a destination such as a department store or a food court, for example. A user may be provided with navigation instructions informing the user to walk in a particular direction for a certain distance or until a landmark has been reached, such as a bench or hallway, and then change direction. For example, upon reaching a bench, a user may be instructed to turn left and continue walking. Navigation instructions to guide a user from a starting location to a destination may include several segments or branches, for example. For example, a navigation instruction to “walk straight for 50 feet” may comprise a first branch and “turn left and walk straight for 60 feet” may comprise a second branch. In an indoor environment, there may be numerous branches along a particular path from a starting location to an end location or destination.

Information relating to a layout of an indoor environment, including the scaling of the map is important in determining appropriate navigation instructions. For example, in order to direct a user along a particular path, correct distances must be determined. However, in some systems, an indoor map is received that has not been correctly scaled.

### BRIEF SUMMARY

According to one aspect of the present disclosure, a computer-implemented method includes receiving an unscaled electronic map, where the unscaled electronic map shows a floor plan of a building in a local coordinate system. The method also includes creating control points on the unscaled electronic map. Each of the control points includes an absolute coordinate pair and a corresponding local coordinate pair of the unscaled electronic map. Further included in the method are calculating a primary scaling factor based on the control points and then auto-scaling the electronic map using the primary scaling factor to generate a scaled electronic map that shows the floor plan of the building.

According to another aspect of the present disclosure, a computer-readable medium includes program code stored thereon. The program code includes instructions to receive an unscaled electronic map, where the unscaled electronic map shows a floor plan of a building in a local coordinate system. The program code also includes instructions to create control points on the unsealed electronic map. Each of the control points includes an absolute coordinate pair and a corresponding local coordinate pair of the unsealed electronic map. Also included in the program code are instructions to calculate a primary scaling factor based on the control points and to then auto-scale the electronic map using the primary scaling factor to generate a scaled electronic map showing the floor plan of the building.

In a further aspect of the present disclosure, a map server includes memory and a processing unit. The memory is adapted to store program code. The processing unit is adapted to access and execute instructions included in the program code. When the instructions are executed by the processing unit, the processing unit directs the map server to receive an unsealed electronic map, where the unsealed electronic map shows a floor plan of a building in a local coordinate system. The program code also includes instructions to direct the map server to create control points on the unsealed electronic map. Each of the control points includes an absolute coordinate pair and a corresponding local coordinate pair of the unsealed electronic map. Also included in the program code are instructions to direct the map server to calculate a primary scaling factor based on the control points and to then auto-scale the electronic map using the primary scaling factor to generate a scaled electronic map showing the floor plan of the building.

In yet another aspect of the present disclosure, a system includes means for receiving an unsealed electronic map, where the unsealed electronic map shows a floor plan of a building in a local coordinate system. The system also includes means for creating control points on the unsealed electronic map. Each of the control points includes an absolute coordinate pair and a corresponding local coordinate pair of the unsealed electronic map. Also included in the system are means for calculating a primary scaling factor based on the plurality of control points and means for auto-scaling the electronic map using the primary scaling factor to generate a scaled electronic map showing the floor plan of the building.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 is a functional block diagram of a computing device having a scaling engine and a user interface.

FIG. 2 illustrates a process of auto-scaling an indoor map.

FIG. 3 illustrates a user interface displaying an unsealed indoor map.

FIG. 4 illustrates a user interface for the user-entry of control point details.

FIG. 5 illustrates a user interface displaying a scaled indoor map.

FIG. 6 illustrates an example output in extensible markup language (XML) format, including a calculated building area.

FIG. 7 illustrates a user interface displaying a scaled indoor map overlaid with an aerial image.

FIG. 8 is a functional block diagram of a navigation system.

FIG. 9 is a functional block diagram of a map server.

### DETAILED DESCRIPTION

Reference throughout this specification to “one embodiment”, “an embodiment”, “one example”, or “an example” means that a particular feature, structure, or characteristic described in connection with the embodiment or example is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. Any example or embodiment described herein is not to be construed as preferred or advantageous over other examples or embodiments.

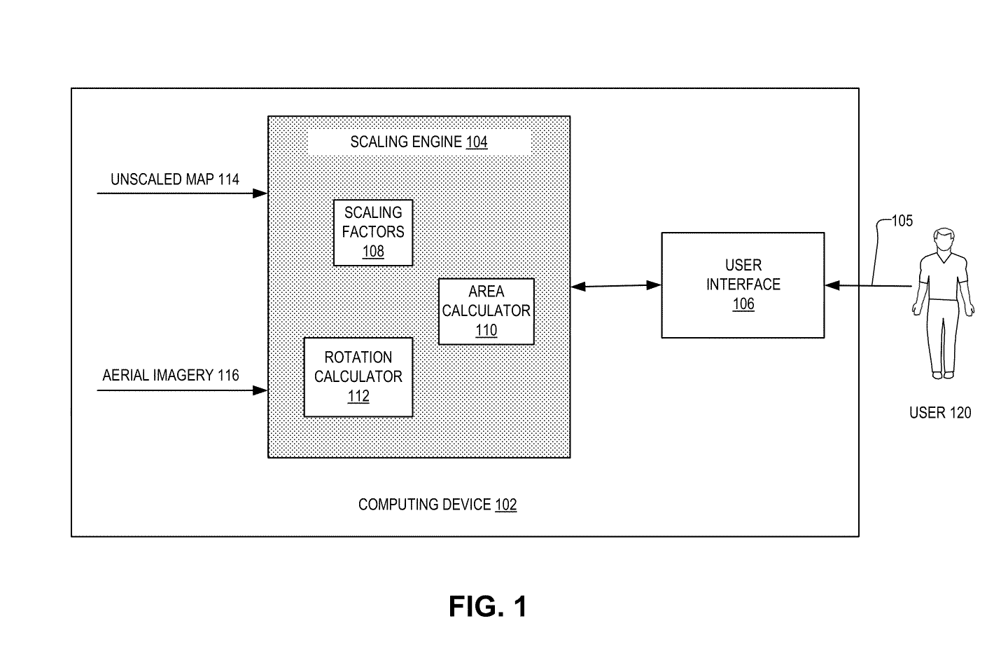

FIG. 1 is a functional block diagram of a computing device 102 having a scaling engine 104 coupled with a user interface 106. The illustrated example of scaling engine 104 includes a scaling factors block 108, an area calculator block 110, and a rotation calculator block 112. Scaling engine 104 is further coupled to receive an unsealed indoor map 114 and optional aerial imagery 116. User interface 106 is to be coupled to receive user input 105 from user 120 by of a user input device, such as a mouse, track pad, keyboard, and the like.

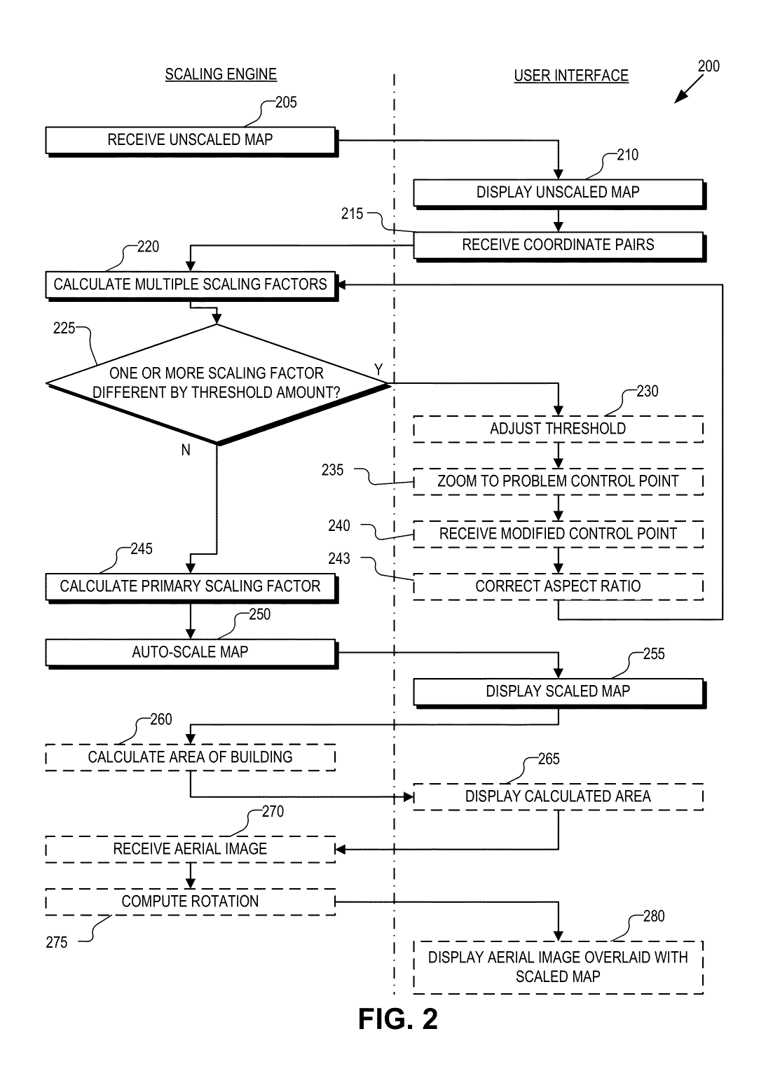

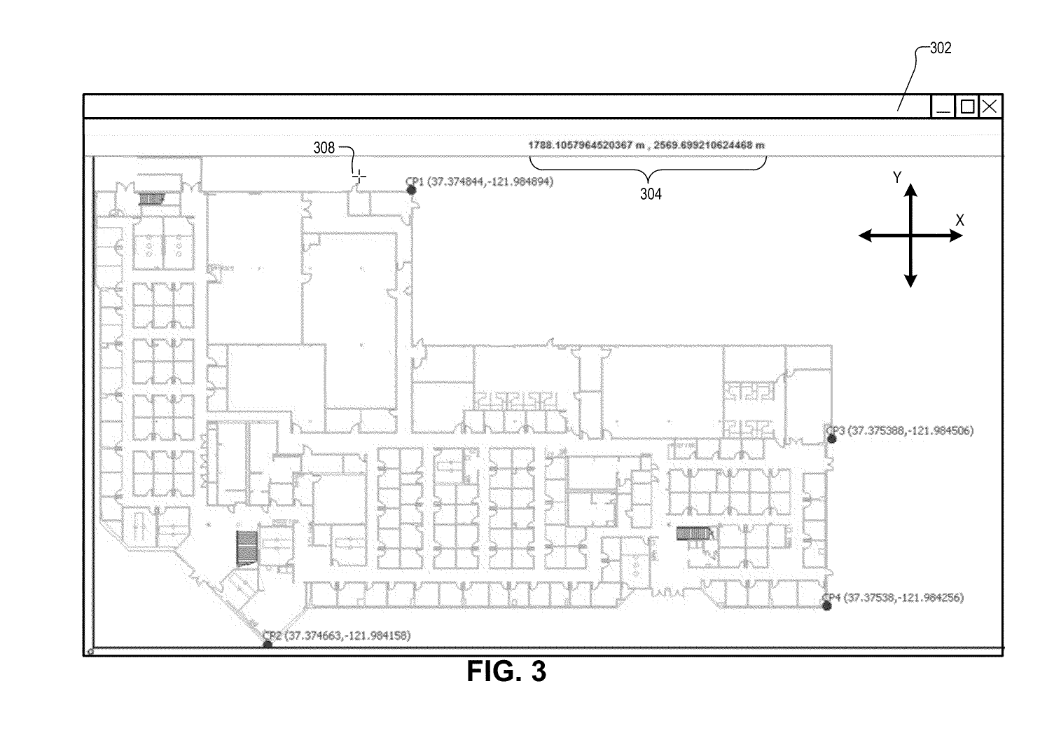

FIG. 2 illustrates a process 200 of auto-scaling an indoor map. The operation of computing device 102 will now be described with reference to FIGS. 1 and 2, as well as FIGS. 3-7. In process block 205, scaling engine 104 receives an unsealed electronic map 114. The unsealed electronic map may be received in a variety of file formats, including, but not limited to, raster based image files such as, *.bmp, *.jpeg, *.tiff, *.raw, *.gif, *.png, or vector based files such as, *.dxf, *.cad, or *.kml.

In one example, the received unsealed electronic map shows floor plan of a building. For example, the floor plan may show indoor features of the building such as a building boundary, interior walls, doorways, hallways, etc. Once scaling engine 104 receives the unsealed map, user interface 106 may display the unsealed map (i.e., process block 210).

FIG. 3 illustrates an example user interface 302 displaying an unsealed indoor map in a local coordinate system. As shown, user interface 302 displays local coordinate pair 304. In one embodiment, local coordinate pair 304 is the current x and y coordinates of the location of cursor 308 on the unsealed electronic map. The x and y coordinate of local coordinate pair 304 may be in units of pixels of the unsealed electronic map. In another embodiment, the received unsealed map may include a coordinate system of its own, providing the relative distances between features within the same building. Thus, in this embodiment, the local coordinate pair 304 may be in units of distance measurement, such as meters or feet. Local coordinate pair 304 may continually update as the user 120 moves the cursor 308 around user interface 302.

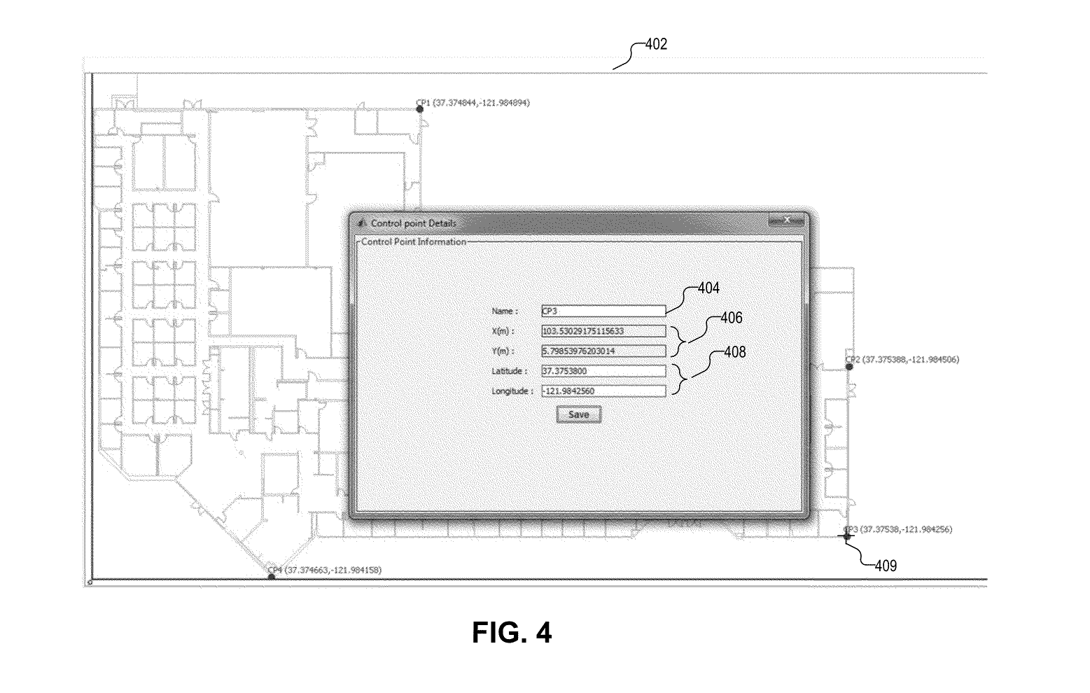

Next, control points are created which will be used by scaling engine 104 to perform the auto-scaling of the electronic map. In process block 215, user interface 106 receives coordinate pairs based on the user input 105. The received coordinate pairs may include the current position of the cursor in local coordinates, and an absolute coordinate pair that corresponds with the current local coordinate pair. In one embodiment, the absolute coordinate pair includes a latitude and a longitude entered by user 120. In response to this received user input 105, user interface 302 creates and marks a control point on the unsealed map. By way of example, FIG. 4 illustrates a user interface 402 for the user-entry of control point details. In this example, user 120 designates a location on the unscaled map where a control point is to be created by positioning cursor 409 at a location within the unscaled map. Then, user interface 402 is displayed to the user. As shown, user interface 402 allows entry of a name 404 for the control point and the entry of the absolute coordinate pair 408 in latitude and longitude. User interface 402 also displays the local coordinate pair 406 as an x and y pair in meters. In response to the user input, the user interface marks the control point on the map. FIG. 4 illustrates several control points that have been entered, including CP1, CP2, CP3, and CP4.

User 120 may then proceed to enter additional control points onto the unscaled map. In one embodiment, three (3) non-collinear control points are necessary for scaling engine 104 to auto-scale the map. In another embodiment, as little as two (2) control points may be used provided scaling engine 104 is also provided with a known aspect ratio. Also, entry of the control points on the building boundary may provide the most accurate auto-scaling by scaling engine 104, but embodiments of the present disclosure are not necessarily limited to entry of control points on the building boundary. For example, control points may be placed on any of the features of the building, as long as the user has a corresponding absolute coordinate pair for entry.

Once multiple control points have been created, process 200 of FIG. 2 may proceed to process block 220, where scaling factor block 108 calculates multiple scaling factors. In one embodiment, the scaling factors are calculated by using several different combinations of the various control points. For example, in the embodiment of FIG. 4, control points CP1 and CP2 may be used to calculate a first scaling factor, while control points CP2 and CP3 may be used to calculate a second scaling factor. In one embodiment, a scaling factor is calculated by taking the ratio of the distance between absolute coordinates and the distance between local coordinates. Scaling factor block 108 may also be configured to determine whether one or more of the control points are incorrect (i.e., wrong local coordinates, or wrong absolute coordinates, etc.). Decision block 225 of FIG. 2, includes determining whether one or more of the calculated scaling factors are different from the other calculated scaling factors by a threshold amount. If so, then at least one of the corresponding control points may be incorrect. Process 200 may then optionally proceed to process block 230 where user interface 302 allows user to adjust the threshold amount by which the scaling factors are compared. That is, user 120 may adjust the amount by which one or more of the scaling factors may differ from the others.

Alternatively, or in combination, process 200 may then proceed to optional process block 235, where user interface 302 may zoom to the incorrect control point to allow user 120 to more accurately place the control point, effectively modifying the local coordinate pair associated with that control point. In process block 240, user interface 302 receives the modified control point and passes it on to the scaling factors block 108 for calculating the scaling factors again.

In one embodiment, if a scaling factor is determined to be different from the other scaling factors by a threshold amount in decision block 225, rather than assuming that a control point is incorrect, scaling engine 104 may, instead, assume that the aspect ratio of the image needs to be corrected. The aspect ratio correction is for the case when the input image (e.g., map 114) is stretched or shrunk in a particular direction. Thus, scaling factors block 108 may modify an aspect ratio of the electronic map in response to determining that one or more of the scaling factors differ by more than the threshold amount. In one embodiment, the correction of the aspect ratio is shown by way of optional process block 243 which includes: (1) calculating an x factor (along the x-axis) and a y factor (along the y-axis) for any two control points in local coordinates; (2) calculating an x factor and a y factor for any two control points in absolute coordinates; (3) computing a first ratio of the local coordinate x factor to the absolute coordinate x factor; (4) computing a second ratio of the local coordinate y factor to the absolute coordinate y factor; and (5) using the first and second ratios to scale a point in both the x and y directions to stretch or shrink the image appropriately. Once the aspect ratio is corrected, process 200 may proceed back to calculating (i.e., process block 220) and comparing (i.e., decision block 225) the multiple scaling factors.

Once satisfied that scaling factors are within the threshold amount, process 200 proceeds to process block 245 where scaling factor block 108 calculates a primary scaling factor. In one embodiment, the primary scaling factor is the mean of the multiple scaling factors calculated in process block 220. In another embodiment, the primary scaling factor is the median of the multiple scaling factors.

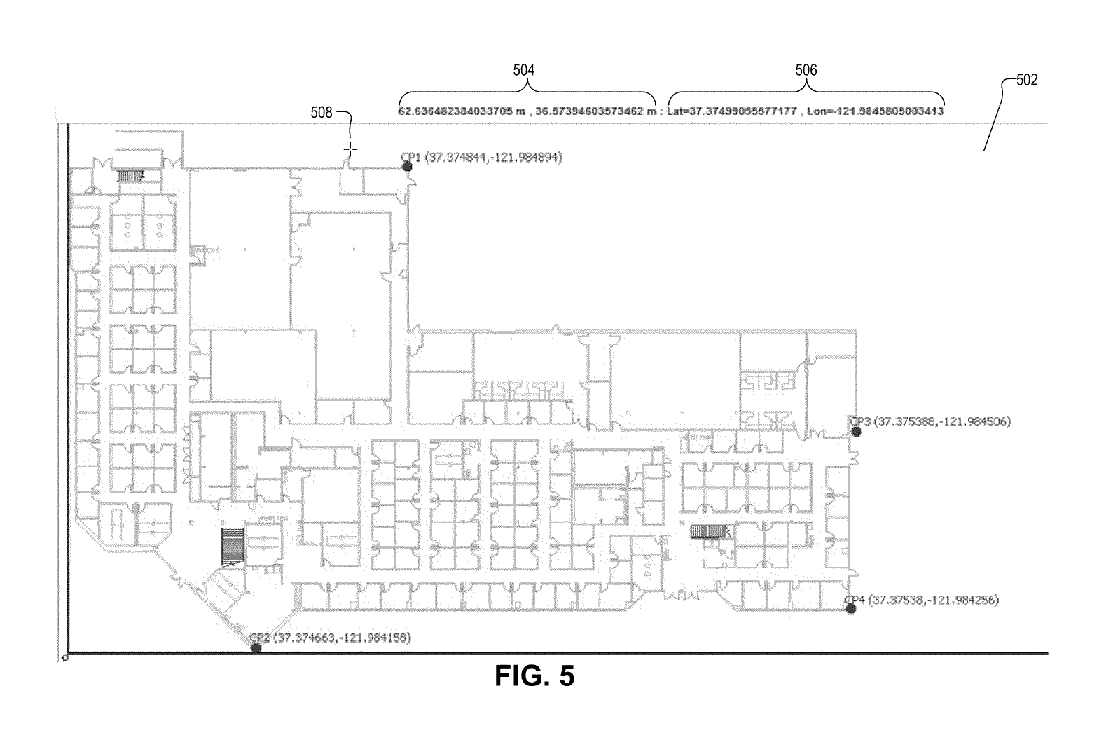

Next, in process block 250, scaling engine 104 then scales the map using the calculated primary scaling factor. The scaled electronic map is then displayed to the user 120 in process block 255. FIG. 5 illustrates a user interface 502 for displaying a scaled indoor map. Similar to user interface 302 of FIG. 3, the user interface 502 of FIG. 5 also displays the local coordinates 504 of the cursor 508. However, since the map is now scaled, user interface 502 may also display the corresponding absolute coordinates 506 of the cursor.

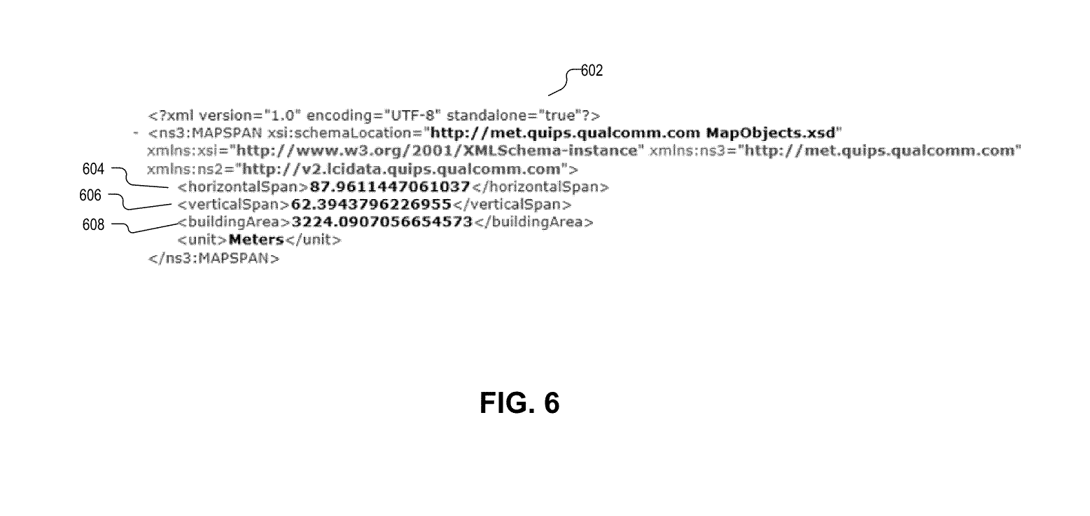

Embodiments of the present disclosure further provide for the validation of the auto-scaled electronic map. One such method is to calculate the building area of the scaled map and comparing it with the known area of the building. Thus, computing device 102 includes an area calculator 110 for calculating the area of the building of the scaled map. Returning now to FIG. 2, process 200 proceeds to optional process block 260, where area calculator 110 calculates the area of the building based on the scaled map. The calculated area may then be displayed to the user (process block 265) or scaling engine 104 may generate a output file that includes the calculated area. The user 120 may then compare the calculated area with the known area to validate the scaling of the map. FIG. 6 illustrates an example output 602 in extensible markup language (XML) format, including a calculated building area 608. As shown, output 602 includes the horizontal span 604 of the building, the vertical span 606 of the building, and the building area 608, all in units of meters and meters2, respectively.

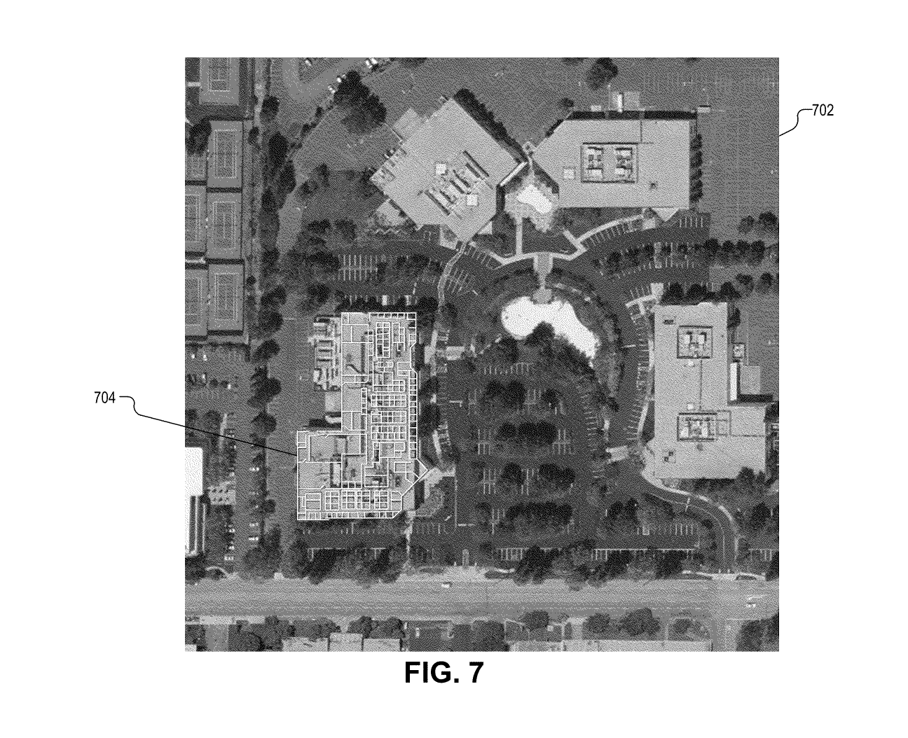

Another method of validating the scaling of the electronic map includes overlaying the scaled map onto aerial photography, such as a satellite image of the area corresponding with the scaled indoor map. However, in order to properly align the building of the scaled map with the actual building shown in the aerial image, a correct rotation of the map needs to be calculated. In optional process block 270 an aerial image corresponding to the scaled indoor map is received. Next, in process block 275, rotation calculator 112 calculates the rotation needed using the entered control points to properly align the building in the electronic map with the corresponding building in the aerial image. FIG. 7 illustrates a user interface that displays an example scaled indoor map 704 overlaid onto an aerial image 702. In the example of FIG. 7, indoor map 704 has been automatically rotated counter-clockwise, so as to properly align with the aerial image. User 120 may then validate the auto-scaling of the electronic map by viewing how closely the building of the auto-scaled map aligns with the corresponding building shown in the aerial image.

Accordingly, embodiments of the present invention provide for the auto-scaling and validation of an electronic indoor map without the need for manual stretching or rotating of the image.

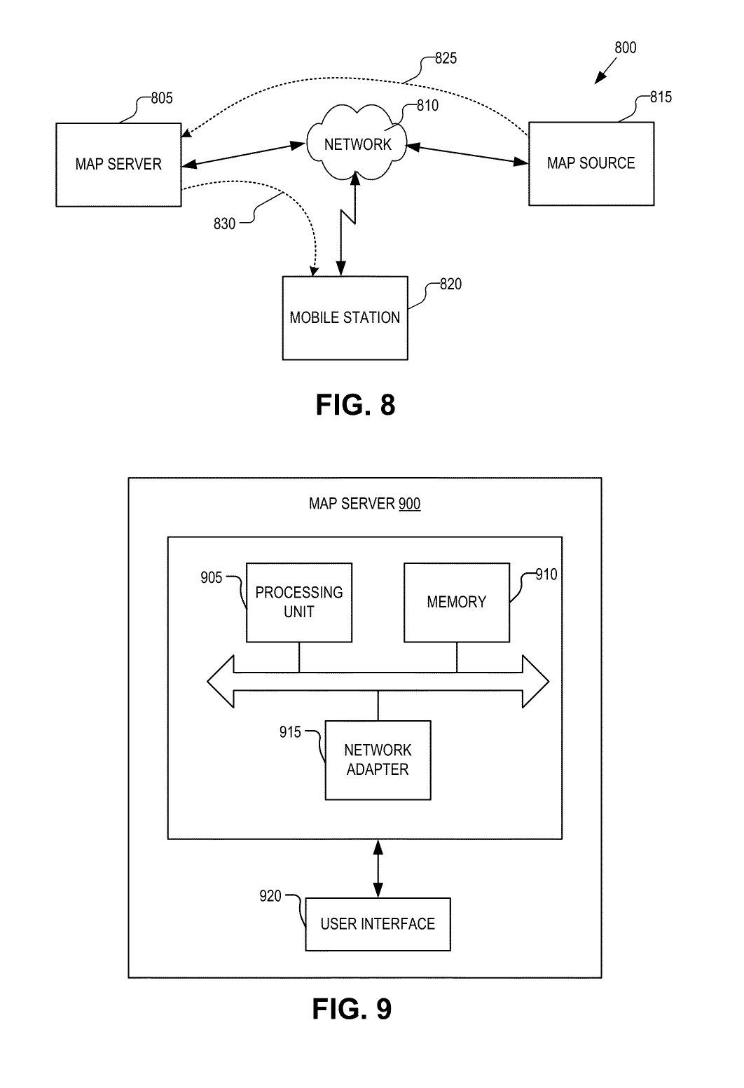

FIG. 8 is a functional block diagram of a navigation system 800. As shown, navigation system 800 may include a map server 805, a network 810, a map source 815, and a mobile station 820. Map source 815 may include a memory and may store electronic maps that may or may not be correctly scaled. Electronic maps may include drawings of line segments which may indicate various interior features of a building.

In one implementation, map source 815 may create electronic maps by scanning paper blueprints for a building into an electronic format that is not correctly scaled. Alternatively, map source 815 may acquire electronic maps from an architectural firm that designed a building or from public records, for example.

Electronic maps 825 may be transmitted by map source 815 to map server 805 via network 810. Map source 815 may include a database or server, for example. In one implementation, map server 805 may transmit a request for a particular basic electronic map to map source 815 and in response the particular electronic map may be transmitted to map server 805. One or more maps in map source 815 may be scanned from blueprint or other documents.

Map server 805 may provide a user interface for a user to identify one or more coordinate points of the electronic map. In response to user input, the map is auto-scaled using the calculated primary scaling factor.

The electronic map may subsequently be utilized by a navigation system to generate various position assistance data that may be used to provide routing directions or instructions to guide a person from a starting location depicted on a map to a destination location in an office, shopping mall, stadium, or other indoor environment. A person may be guided through one or more hallways to reach a destination location. Electronic maps and/or routing directions 830 may be transmitted to a user's mobile station 820. For example, such electronic maps and/or routing directions may be presented on a display screen of mobile station 820. Routing directions may also be audibly presented to a user via a speaker of mobile station 820 or in communication with mobile station 820. Map server 805, map source 815 and mobile station 820 may be separate devices or combined in various combinations (e.g., all combined into mobile station 820; map source 815 combined into map server 805, etc.).

FIG. 9 is a functional block diagram of a map server 900. Map server 900 may include a processing unit 905, memory 910, and a network adapter 915. Memory 910 may be adapted to store computer-readable instructions, which are executable to perform one or more of processes, implementations, or examples thereof which are described herein. Processing unit 905 may be adapted to access and execute such machine-readable instructions. Through execution of these computer-readable instructions, processing unit 905 may direct various elements of map server 900 to perform one or more functions. Also, map server 900 is one possible implementation of computing device 102 of FIG. 1.

Memory 910 may also store electronic maps to be analyzed and auto-scaled, as discussed above. Network adapter 915 may transmit one or more electronic maps to another device, such as a user's mobile device. Upon receipt of such electronic maps, a user's mobile device may present updated electronic maps via a display device. Network adapter 915 may also receive one or more electronic maps for analysis from an electronic map source.

The order in which some or all of the process blocks appear in each process should not be deemed limiting. Rather, one of ordinary skill in the art having the benefit of the present disclosure will understand that some of the process blocks may be executed in a variety of orders not illustrated.

The teachings herein may be incorporated into (e.g., implemented within or performed by) a variety of apparatuses (e.g., devices). For example, one or more aspects taught herein may be incorporated into a mobile station, phone (e.g., a cellular phone), a personal data assistant (“PDA”), a tablet, a mobile computer, a laptop computer, a tablet, an entertainment device (e.g., a music or video device), a headset (e.g., headphones, an earpiece, etc.), a medical device (e.g., a biometric sensor, a heart rate monitor, a pedometer, an EKG device, etc.), a user I/O device, a computer, a server, a point-of-sale device, an entertainment device, a set-top box, or any other suitable device. These devices may have different power and data requirements and may result in different power profiles generated for each feature or set of features.

As used herein, a mobile station (MS) refers to a device such as a cellular or other wireless communication device, personal communication system (PCS) device, personal navigation device (PND), Personal Information Manager (PIM), Personal Digital Assistant (PDA), laptop, tablet or other suitable mobile device which is capable of receiving wireless communication and/or navigation signals. The term “mobile station” is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile station” is intended to include all devices, including wireless communication devices, computers, laptops, etc. which are capable of communication with a server, such as via the Internet, Wi-Fi, or other network, and regardless of whether satellite signal reception, assistance data reception, and/or position-related processing occurs at the device, at a server, or at another device associated with the network. Any operable combination of the above are also considered a “mobile station.”

In some aspects a wireless device may include an access device (e.g., a Wi-Fi access point) for a communication system. Such an access device may provide, for example, connectivity to another network (e.g., a wide area network such as the Internet or a cellular network) via a wired or wireless communication link. Accordingly, the access device may enable another device (e.g., a Wi-Fi station) to access the other network or some other functionality. In addition, it should be appreciated that one or both of the devices may be portable or, in some cases, relatively non-portable.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, engines, circuits, and algorithm steps described in connection with the embodiments disclosed herein may be implemented as electronic hardware, computer software, or combinations of both. To clearly illustrate this interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal In the alternative, the processor and the storage medium may reside as discrete components in a user terminal.

In one or more exemplary embodiments, the functions described may be implemented in hardware, software, firmware, or any combination thereof. If implemented in software as a computer program product, the functions may be stored on or transmitted over as one or more instructions or code on a non-transitory computer-readable medium. Computer-readable media can include both computer storage media and communication media including any medium that facilitates transfer of a computer program from one place to another. A storage media may be any available media that can be accessed by a computer. By way of example, and not limitation, such non-transitory computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of non-transitory computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A computer-implemented method, comprising:
receiving an unscaled electronic map, wherein the unscaled electronic map shows a floor plan of a building in a local coordinate system;
creating a plurality of control points on the unscaled electronic map, wherein each of the plurality of control points comprises an absolute coordinate pair and a corresponding local coordinate pair of the unscaled electronic map;
calculating a primary scaling factor based on the plurality of control points; and
auto-scaling the electronic map using the primary scaling factor to generate a scaled electronic map showing the floor plan of the building.

2. The computer-implemented method of claim 1, wherein creating the plurality of control points comprises:
displaying a user interface on a display device, the user interface comprising the unscaled electronic map and a current position of a cursor in local coordinates;
receiving user input indicating that the current position of the cursor is to be included in one of the plurality of control points; and
receiving user input indicating absolute coordinates of the one of the plurality of control points.

3. The method of claim 1, wherein calculating the primary scaling factor includes:
calculating a first scaling factor using a first combination of the plurality of control points; and
calculating a second scaling factor using a second combination of the plurality of control points, wherein the primary scaling factor is the mean of the first scaling factor and the second scaling factor.

4. The method of claim 1, wherein calculating the primary scaling factor includes:
calculating a first scaling factor using a first combination of the plurality of control points; and
calculating a second scaling factor using a second combination of the plurality of control points, wherein the primary scaling factor is the median of the first scaling factor and the second scaling factor.

5. The method of claim 1, further comprising calculating the area of the building of the scaled electronic map and displaying the calculated area on a display device to validate the auto-scaling.

6. The method of claim 1, further comprising overlaying the scaled electronic map on an aerial image of the building on a display device to validate the auto-scaling.

7. The method of claim 6, wherein overlaying the scaled electronic map on the aerial image includes computing a rotation of the scaled electronic map to align the building of the scaled electronic map with the building of the aerial image.

8. The method of claim 1, further comprising determining whether one or more of the control points are incorrect.

9. The method of claim 8, receiving user input representative of at least one of a modified absolute coordinate pair and a modified local coordinate pair of at least one of the plurality of control points in response to determining that the at least one of the control points is incorrect.

10. The method of claim 9, further comprising displaying a zoomed-in region of the unscaled electronic map to allow a more accurate placement of the control point by a user.

11. The method of claim 8, wherein determining whether one or more of the control points are incorrect includes calculating a scaling factor for a variety of combinations of the control points, wherein a control point is an incorrect control point if its respective scaling factor is different from other calculated scaling factors by a threshold amount.

12. The method of claim 11, further comprising receiving user input to adjust the threshold amount.

13. The method of claim 1, further comprising
determining whether an aspect ratio of the electronic map is incorrect; and
calculating a scaling factor for a variety of combinations of the control points, wherein the aspect ratio is incorrect if a scaling factor is different from other calculated scaling factors by a threshold amount.

14. The method of claim 1, wherein the absolute coordinates include a latitude and longitude of the control point.

15. The method of claim 1, wherein the local coordinate pair includes x and y coordinates of the unsealed electronic map.

16. The method of claim 15, wherein the x and y coordinates of the unsealed electronic map are in units of pixels of the unsealed electronic map.

17. A computer-readable medium including program code stored thereon, the program code comprising instructions to:
receive an unsealed electronic map, wherein the unsealed electronic map shows a floor plan of a building in a local coordinate system;
create a plurality of control points on the unsealed electronic map, wherein each of the plurality of control points comprises an absolute coordinate pair and a corresponding local coordinate pair of the unsealed electronic map;
calculate a primary scaling factor based on the plurality of control points; and
auto-scale the electronic map using the primary scaling factor to generate a scaled electronic map showing the floor plan of the building.

18. The computer-readable medium of claim 17, wherein the instructions to create the plurality of control points comprises instructions to:
display a user interface on a display device, the user interface comprising the unscaled electronic map and a current position of a cursor in local coordinates;
receive user input indicating that the current position of the cursor is to be included in one of the plurality of control points; and
receive user input indicating absolute coordinates of the one of the plurality of control points.

19. The computer-readable medium of claim 17, wherein the instructions to calculate the primary scaling factor includes instructions to:
calculate a first scaling factor using a first combination of the plurality of control points; and
calculate a second scaling factor using a second combination of the plurality of control points, wherein the primary scaling factor is responsive to both the first and second scaling factors.

20. The computer-readable medium of claim 17, further comprising instructions to calculate the area of the building of the scaled electronic map and displaying the calculated area on a display device to validate the auto-scaling.

21. The computer-readable medium of claim 17, further comprising instructions to overlay the scaled electronic map on an aerial image of the building on a display device to validate the auto-scaling.

22. The computer-readable medium of claim 17, further comprising instructions to calculate a scaling factor for a variety of combinations of the control points to determine whether one or more of the control points are incorrect, wherein a control point is an incorrect control point if its respective scaling factor is different from other calculated scaling factors by a threshold amount.

23. The computer-readable medium of claim 17, further comprising instructions to:
determine whether an aspect ratio of the electronic map is incorrect; and
calculate a scaling factor of for a variety of combinations of the control points, wherein the aspect ratio is incorrect if a scaling factor is different from other calculated scaling factors by a threshold amount.

24. The computer-readable medium of claim 17, wherein the absolute coordinates include a latitude and longitude of the control point.

25. The computer-readable medium of claim 17, wherein the local coordinate pair includes x and y coordinates of the unscaled electronic map in units of pixels.

26. A map server, comprising:
memory adapted to store program code; and
a processing unit adapted to access and execute instructions included in the program code, wherein when the instructions are executed by the processing unit, the processing unit directs the map server to:
receive an unscaled electronic map, wherein the unscaled electronic map shows a floor plan of a building in a local coordinate system;
create a plurality of control points on the unscaled electronic map, wherein each of the plurality of control points comprises an absolute coordinate pair and a corresponding local coordinate pair of the unscaled electronic map;
calculate a primary scaling factor based on the plurality of control points; and
auto-scale the electronic map using the primary scaling factor to generate a scaled electronic map showing the floor plan of the building.

27. The map server of claim 26, wherein the instructions to create a plurality of control points includes instructions to:
display a user interface on a display device, the user interface comprising the unscaled electronic map and a current position of a cursor in local coordinates;
receive user input indicating that the current position of the cursor is to be included in one of the plurality of control points; and
receive user input indicating absolute coordinates of the one of the plurality of control points;

28. The map server of claim 26, wherein the instructions to calculate the primary scaling factor includes instructions to:
calculate a first scaling factor using a first combination of the plurality of control points; and
calculate a second scaling factor using a second combination of the plurality of control points, wherein the primary scaling factor is responsive to both the first and second scaling factors.

29. The map server of claim 26, wherein the program code further includes instructions to direct the map server to overlay the scaled electronic map on an aerial image of the building on a display device to validate the auto-scaling.

30. The map server of claim 26, wherein the program code further includes instructions to direct the map server to calculate a scaling factor for a variety of combinations of the control points to determine whether one or more of the control points are incorrect, wherein a control point is an incorrect control point if its respective scaling factor is different from other calculated scaling factors by a threshold amount.

31. The map server of claim 26, wherein the program code further includes instructions to direct the map server to:
determine whether an aspect ratio of the electronic map is incorrect; and
calculate a scaling factor of for a variety of combinations of the control points, wherein the aspect ratio is incorrect if a scaling factor is different from other calculated scaling factors by a threshold amount.

32. The map server of claim 26, wherein the absolute coordinates include a latitude and longitude of the control point.

33. The map server of claim 26, wherein the local coordinate pair includes x and y coordinates of the unscaled electronic map in units of pixels.

34. A system, comprising:
means for receiving an unscaled electronic map, wherein the unscaled electronic map shows a floor plan of a building in a local coordinate system;
means for creating a plurality of control points on the unscaled electronic map, wherein each of the plurality of control points comprises an absolute coordinate pair and a corresponding local coordinate pair of the unscaled electronic map;
means for calculating a primary scaling factor based on the plurality of control points; and
means for auto-scaling the electronic map using the primary scaling factor to generate a scaled electronic map showing the floor plan of the building.

35. The system of claim 34, wherein the means for creating a plurality of control points includes:
means for displaying a user interface on a display device, the user interface comprising the unscaled electronic map and a current position of a cursor in local coordinates;
means for receiving user input indicating that the current position of the cursor is to be included in one of the plurality of control points; and
means for receiving user input indicating absolute coordinates of the one of the plurality of control points.

36. The system of claim 34, further comprising
means for calculating a first scaling factor using a first combination of the plurality of control points; and
means for calculating a second scaling factor using a second combination of the plurality of control points, wherein the primary scaling factor is responsive to both the first and second scaling factors.

37. The system of claim 34, further comprising means for calculating a scaling factor for a variety of combinations of the control points to determine whether one or more of the control points are incorrect, wherein a control point is an incorrect control point if its respective scaling factor is different from other calculated scaling factors by a threshold amount.

38. The system of claim 34, wherein the absolute coordinates include a latitude and longitude of the control point.

39. The system of claim 34, wherein the local coordinate pair includes x and y coordinates of the unscaled electronic map in units of pixels.
